(19) United States
(12) Patent Application Publication
(10) Pub. No.: US 2020/0226133 A1
(43) Pub. Date: Jul. 16, 2020

(54) KNOWLEDGE MAP BUILDING SYSTEM AND METHOD

(71) Applicants: HITHINK ROYALFLUSH INFORMATION NETWORK CO., LTD., Hang Zhou, Zhejiang (CN); HITHINK FINANCIAL SERVICES INC., Chicago, IL (US)

(72) Inventor: Chengjun LI, Hangzhou (CN)

(73) Assignee: HITHINK FINANCIAL SERVICES INC., Chicago, IL (US)

(21) Appl. No.: 16/342,969

(22) PCT Filed: Oct. 18, 2016
(86) PCT No.: PCT/CN2016/102331

§ 371 Date: Jan. 6, 2020

(51) Int. Cl. G06F 16/2458; G06F 16/248; G06F 16/28

(52) U.S. Cl. CPC G06F 16/2465; G06F 16/283; G06F 16/248

(57) ABSTRACT

The present disclosure discloses a knowledge map building method that includes obtaining user input data, querying a database based on the user input data, and obtaining target node information and association node information. A correlation between the target node and the association node may be present. The node information is analyzed, and a knowledge map is constructed based on the analysis results. The knowledge map is presented to the user. The user may modify this knowledge map, and the knowledge map may be presented to the user again. The modified knowledge map and user data may be stored in a database as a basis for big data analysis. In addition, a report may also be constructed based on the node information in the process of building the knowledge map.

### TECHNICAL FIELD

The present disclosure relates to the field of information query, in particular, to systems and methods for building a knowledge map, and to systems and methods for building a data report based on the knowledge map.

### BACKGROUND

In recent years, network and database technologies have developed rapidly, and the amount of data has been expanding. People need to use database searches to obtain information they want. Usually, when people query a database, the database uses a specific method to capture as much as possible information that the user may want from the vast data world according to a specific logic. After obtaining a user instruction, the computer may process the user instruction. Data is retrieved from the database based on the processed instructions and then sorted into a user-friendly presentation form.

In traditional query methods, the way of data search is relatively similar, which is generally conducted hierarchically based on nodes. The presentation of data is fixed and unified, no matter whether the result is a data browser, a special report or an economic database. There is no personalized setting. The user query is difficult, and relevant results of the query are not the results that the user wants, which is not targeted. This way of retrieving information is less efficient. Therefore, the present disclosure provides systems and methods for building a knowledge map presenting a personalized structure based on industry specificities, which changes the traditional node search method.

The knowledge map is intended to describe various entities (such as people, Chinese characters, videos, music, movies, novels, etc.) or concepts that exist in the real world. Each entity or concept is identified by a globally unique identification number. The intrinsic properties of the entity is characterized using attribute-value pairs. A correlation is used to connect two entities and characterize the association between them. The knowledge map can also be considered as a huge mesh diagram, where the entities in the mesh diagram represent the entities or the concepts, and edges in the mesh diagram consist of the attributes or the correlations. The knowledge map is mainly intended to build and maintain the correlation between entities, and to provide support for functions in the query such as recommendation, semantic understanding, and question answering.

### SUMMARY

A method of building a knowledge map is provided based on one aspect of the present disclosure. The method includes obtaining user input data and retrieving a database based on the user input data to obtain data node information. The data node information may include target node information and a plurality of association nodes information related to the target node information. The data node information is analyzed, and a knowledge map is constructed based on the analysis result. The constructed knowledge map is presented to the user. Modification instruction by the user for modifying the knowledge map is received, and a modified knowledge map is presented to the user.

A system for building the knowledge map is provided based on another aspect of the present disclosure. The system contains a user input module, configured to obtain the user input data. An analysis module is configured to query a database based on the user input data to obtain data node information and analyze the data node information, the data node information includes target node information and a plurality of association nodes information related to the target node information. A knowledge map generation module is configured to construct a knowledge map based on the analysis result. A presenting module is configured to cause the knowledge map to be presented to the user. A user modification module is configured to receive from the user a modification instruction for modifying the knowledge map and cause the presenting module to present the modified knowledge map to the user.

In some embodiments, the retrieving a database based on the user input data to obtain target node information may include identifying the target node in the database based on the user data and further searching for, based on the found target node, other nodes related to the target node in the database as one or more association nodes.

In some embodiments, the analyzing the data node information includes at least one of classifying the data node information, determining a strength of a correlation between the target node and each of the association nodes, or assessing a data quality of the association node.

In some embodiments, the knowledge map generating method may further include generating a report based on the analysis result and presenting the generated report to the user.

In some embodiments, the generating the report based on the analysis result includes obtaining the analysis result, obtaining user data, selecting a report type of the report that needs to be generated, filtering the data node information in the analysis result, and generating a report based on the user data, the selected report type, and the filtered data node information.

In some embodiments, the report type includes at least one of a statistics chart, a statistics table, or a text template of a fixed format.

In some embodiments, the constructing a knowledge map based on the analysis result includes putting the target node in a central location, arranging one or more association nodes around the target node, and for each of the one or more association nodes, connecting the target node with the association node using a line and annotating a correlation between the target node and the association node on the line.

In some embodiments, the receiving from the user the modification instruction for modifying the knowledge map and presenting a modified knowledge map to the user may include receiving the modification instructions of the user, modifying the analysis result of the user input data based on the modification instructions of the user, modifying the knowledge map based on the modified analysis result, generating a mark for a content modified based on the modification instruction of the user, and presenting the modified knowledge map and the mark to the user.

In some embodiments, the receiving from the user the modification instruction for modifying the knowledge map and causing the modified knowledge map to be presented to the user may further include storing the content modified based on the modification instruction of the user and user identity information in a database.

In some embodiments, the receiving from the user the modification instruction for modifying the knowledge map and causing the modified knowledge map to be presented to the user may further include synchronously modifying a report based on the modified analysis result and causing the modified report to be presented to the user.

### BRIEF DESCRIPTION OF THE DRAWINGS

The drawings described herein are provided to provide a further understanding of the present disclosure and form a part of the present disclosure. The illustrative embodiments of the present disclosure and the description thereof are used to explain the present disclosure and do not constitute a limitation of the present disclosure.

FIG. 1 is a schematic diagram of an exemplary system configuration according to some embodiments of the present disclosure.

FIG. 2 is a schematic diagram of an exemplary architecture of a computer device configuration of a knowledge map building system.

FIG. 3 is an exemplary system diagram for performing the knowledge map building according to some embodiments of the present disclosure.

FIG. 4 is a schematic diagram of an analysis module according to some embodiments of the present disclosure.

FIG. 5 is a schematic diagram of an example of the knowledge map generation module according to some embodiments of the present disclosure.

FIG. 6 is a schematic diagram of an example of a report generation module according to some embodiments of the present disclosure.

FIG. 7 is a schematic diagram of an example of a user modification module according to some embodiments of the present disclosure.

FIG. 8 is an exemplary flowchart for building the knowledge map according to some embodiments of the present disclosure.

FIG. 9 is an exemplary flowchart for analyzing user input data based on data in a database in a process of building the knowledge map according to some embodiments of the present disclosure.

FIG. 10 is an exemplary flowchart of generating the knowledge map based on the analysis result according to some embodiments of the present disclosure.

FIG. 11 is an exemplary flowchart of report generation according to some embodiments of the present disclosure.

FIG. 12 is an exemplary flowchart of modifying the knowledge map by a user according to some embodiments of the present disclosure.

FIG. 13 is an example of the knowledge map according to some embodiments of the present disclosure.

FIG. 14 is an example of the knowledge map according to some embodiments of the present disclosure.

FIG. 15 is an example of the report generation according to some embodiments of the present disclosure.

### DETAILED DESCRIPTION

As used in the disclosure and the appended claims, the singular forms “a,” “an,” and “the” include plural referents unless the content clearly dictates otherwise. In general, the terms “comprise” and “include” merely prompt to include steps and elements that have been clearly identified, and these steps and elements do not constitute an exclusive listing. The methods or devices may also include other steps or elements. The term “based on” is “based at least in part on.” The term “one embodiment” means “at least one embodiment”; the term “another embodiment” means “at least one additional embodiment.” The relevant definitions of other terms may be given in the description below.

While the present disclosure makes various references to certain modules in the system according to some embodiments of the present disclosure, any number of different modules may be used and run in a secure system. These modules are illustrative only, and different aspects of the system and the method may use different modules.

The flowcharts used in the present disclosure illustrate operations that systems implement according to some embodiments in the present disclosure. It is to be expressly understood, the operations above or below may or may not be implemented in order. Conversely, the operations may be performed in inverted order, or simultaneously. Besides, one or more other operations may be added to the flowcharts, or one or more operations may be omitted from the flowcharts.

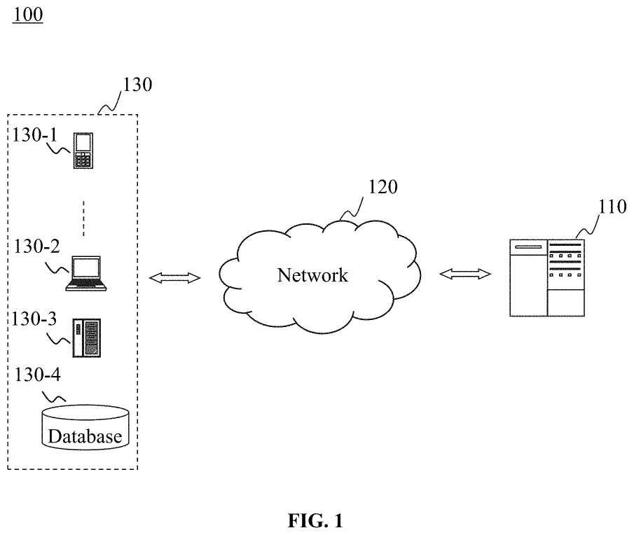

FIG. 1 is a schematic diagram of an exemplary system configuration according to some embodiments of the present disclosure. The system configuration 100 may include but is not limited to, a knowledge map building system 110, one or more networks 120, and one or more information sources 130. The knowledge map building system 110 may be configured to retrieve information provided by the information source and build a knowledge map and/or a report. The knowledge map building system 110 may be a server or a server group. The server group may be centralized, for example, a data center. The server group may also be distributed, for example, a distributed system. The knowledge map building system 110 may be local or remote. The network 120 may be a channel for providing information exchange.

The network 120 may be a single network or a combination of networks. The network 120 may include but is not limited to, one or more combinations of a local area network, a wide area network, a public network, a private network, a wireless local area network, a virtual network, a metropolitan area network, a public switched telephone network, or the like. The network 120 may include various network access points, for example, wired or wireless access points, base station or network switch points, by which data source may be connected with the network 120 and the information may be transmitted through the network. The information source 130 may provide various information.

The information source 130 may include one or more servers, one or more communication terminals, or a combination of the one or more servers and the one or more communication terminals. Further, the server may include a web server, a file server, a database server, an FTP server, an application server, a proxy server, or the like, or any combination thereof. The server may be a server based on one or more social media. The communication terminal may be a mobile phone, a personal computer, a wearable device, a tablet computer, a smart TV, or the like, or any combination of the communication terminals. The communication terminal may also be another electronic device that contains a communication function and a user interaction function. The information source 130 may send the information and the data to the knowledge map building system 110 through the network 120. The information source 130 may be input information of the user, or may be information provided by another database or another information source. The knowledge map building system 110 may send the knowledge map and/or the report results through the network 120 to the information source 130. Other information sources 104 may include, but are not limited to, shopping websites, portals, stock exchanges, microblogs, blogs, personal websites, libraries, etc., which may provide various information. The information source 130 may exist in a form of a single database, a form of a plurality of databases connected through a network, or a form of a large number of personal devices. When the information source exists in the form of a large number of personal devices, the personal devices may generate content (e.g., as referred to as the “user-generated content”), for example, by uploading a text, voice, an image, or a video to a cloud server. The information source may thus be generated by the cloud server and the plurality of personal devices connected to the cloud server. In some embodiments, the information source 130 may provide some related information, including but not limited to securities stocks, market analysis, social hotspots, financial perspectives, market analysis, industry research reports, company announcements, investment opportunities, funds, commodities, Hong Kong stocks, US stocks, or the like, or any combination thereof.

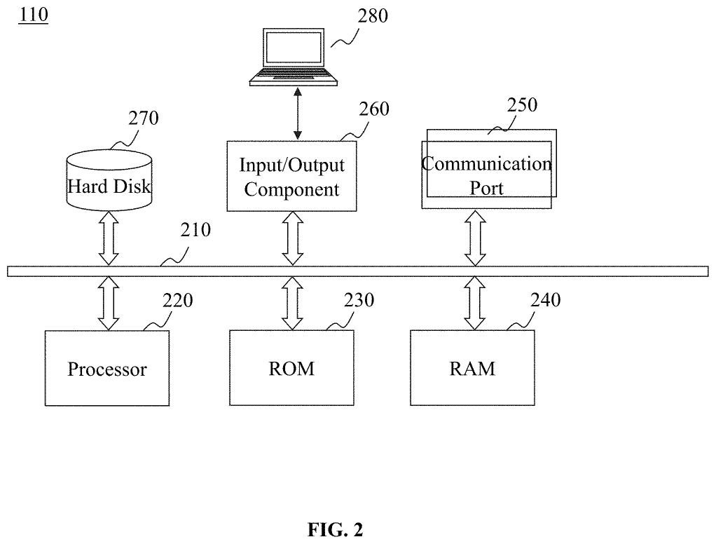

FIG. 2 is a schematic diagram of an exemplary architecture of a computer device configuration of the knowledge map building system 110. A computer may be configured to implement the particular system disclosed in the implementation of the present disclosure. The particular system may use a functional block diagram to explain the hardware platform containing one or more user interfaces. The computer may implement one or more components, modules, units, or sub-units that currently describe the knowledge map building system 110. Additionally, the system 100 may be implemented by the computer through its hardware devices, software programs, firmware, and combinations thereof. The computer may be a computer with general or specific functions. Both computers may be configured to implement the specific system in the embodiment. For convenience, only a computer is illustrated in FIG. 2, but the related computer function described in this embodiment for providing the knowledge required for the knowledge map building may be implemented in a distributed manner by a similar set of platforms, and the processing load of the distributed system is distributed.

As shown in FIG. 2, the computer may include an internal communication bus 210, a processor 220, a read-only memory (ROM) 230, a random-access memory (RAM) 240, a communication port 250, an input/output component 260, a hard disk 270, and a user interface 280. The internal communication bus 210 may be configured to implement data communication between computer components. The processor 220 is configured to execute any of a function, a component, a module, a unit, or a sub-unit of the knowledge map building system 110 described in this disclosure. The processor 220 is composed of one or more processors. In some embodiments, the type of the processor 220 may include but not limited to a Central Processing Unit (CPU), an Application Specific Integrated Circuit (ASIC), an Application Specific Instruction Set Processor (ASIP), a Physics Processing Unit (PPC), a Digital Processing Processor (DSP), a Field-Programmable Gate Array (FPGA), a Programmable Logic Device (PLD), a processor, a microprocessor, a controller, a microcontroller, or the like, or any combination thereof.

The computer also includes different forms of storage devices for storing programs and data. For example, the hard disk 270, the read-only memory (ROM) 230, the random-access memory (RAM) 240, various data files that may be used for computer processing and/or communication, and possible program instructions executed by the processor 220. The storage device may be internal to the knowledge map building system 110 or may be external to the knowledge map building system 110 (e.g., may be connected through a communication device 205). A storage device 202 may include main storage, auxiliary storage, cache storage, control storage, or the like. The storage device may be local or remote (e.g., a network or a cloud). The storage device may directly store information, or the information may be digitized and then stored in the storage device by means of electric, magnet, or optics. The storage device may be a device that uses electrical energy to store information, such as various memories, the random-access memory (RAM), the read-only memory (ROM), or the like. The RAM may include but not limited to a decatron, a selectron, a delay line memory, a Williams tube, a dynamic random access memory (DRAM), a static random access memory (SRAM), a thyristor random access memory (T-RAM), a zero capacitor random access memory (Z-RAM), or the like, or any combination thereof. The read-only memory includes but is not limited to a magnetic bubble memory, a magnetic button line memory, a thin-film memory, a magnetic plate line memory, a magnetic core memory, a drum memory, an optical disk drive, a hard disk, a magnetic tape, a phase change memory, a magnetoresistive random storage memory, a ferroelectric random storage memory, a non-volatile SRAM, a flash memory, an electronic erasable rewritable read-only memory, a erasable programmable read-only memory, a programmable read-only memory, a shielded heap read memory, a floating connection gate random access memory, a nano random access memory, a track memory, a variable resistive memory, a programmable metallization unit, or the like, or any combination thereof. The storage device may be a device that uses magnetic energy to store the information, such as the hard disk, a floppy disk, the magnetic tape, the magnetic core memory, the magnetic bubble memory, a USB flash drive, the flash memory, or the like. The storage device may be a device that uses optics to store information, such as a CD or a DVD. The storage device may be a device that uses magneto-optical to store the information, such as a magneto-optical disk. The storage device may be accessed by random storage, serial access storage, read-only storage, or the like, or any combination thereof. The storage device may be a non-persistent memory or a permanent memory. The storage devices mentioned above are just some examples, and the storage device used by the knowledge map building system 110 may not be limited to this.

The communication port 250 may be configured to implement data communication (e.g., through the network 120) between the computer and other components of the system 100 (e.g., the information source 130). The input/output component 260 supports input/output data flow between the computer and the other components of system 100 (e.g., the user interface 280). The computer may also send and receive information and data from the network 120 through the communication port 250. A form of output information of the knowledge map building system 110 includes but is not limited to numbers, characters, instructions, pressure, sound, images, systems, software, programs, or the like, or any combination thereof. In some embodiments, the input/output component 260 may include but is not limited to displays, printers, plotters, image output devices, language output devices, or the like, or any combination thereof. The output of the information may be sent to the user or may not be sent. The unsent output information may be stored in the storage device or may be deleted.

It should be noted that the storage device (e.g., the hard disk 270, the read-only memory (ROM) 230, or the random access memory (RAM) 240) and/or processor 220 may actually exist in the system, and corresponding functions may also be completed through a cloud computing platform. The cloud computing platform may include but is not limited to a data storing based storage cloud platform, a data processing based computing cloud platform, or an integrated cloud computing platform of the data storing and processing. The cloud platform used by the knowledge map building system 110 may be a public cloud, a private cloud, a community cloud, or a hybrid cloud. For example, a part of the information received by the knowledge map building system 110 may be counted, calculated, and/or stored by the cloud platform based on actual needs. Another part of the information may be calculated and/or stored by a local processing device and/or the storage device.

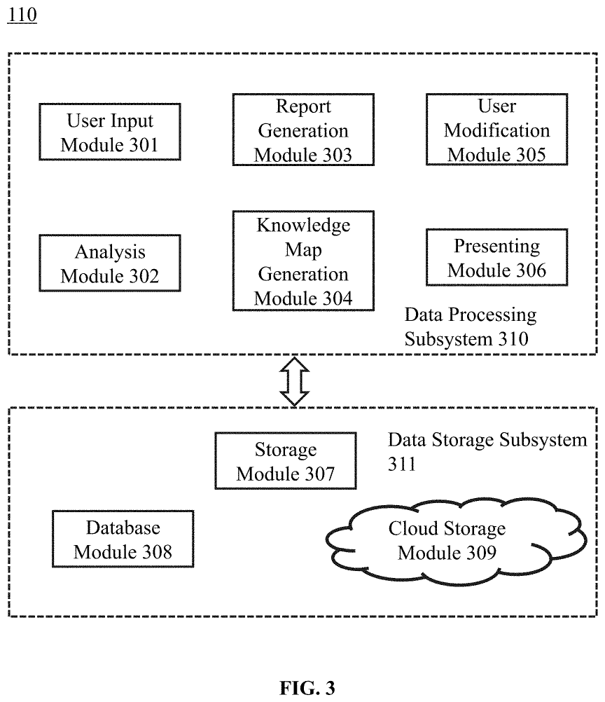

FIG. 3 is an exemplary system diagram for performing the knowledge map building according to some embodiments of the present disclosure. The knowledge map building system 110 includes a data processing subsystem 310 and a data storage subsystem 311. A connection may be established between the data processing subsystem 310 and the data storage subsystem 311 for data exchange. The data processing subsystem 310 includes a user input module 301, an analysis module 302, a report generation module 303, a knowledge map generation module 304, a user modification module 305, and a presenting module 306. The data storage subsystem 311 includes a storage module 307, a database module 308, and a cloud storage module 309.

The terms “module”, “submodule”, “unit”, and “sub-unit” in the present disclosure refer to logic or a set of software instructions stored in hardware or firmware. The “module”, “submodule”, “unit”, “sub-unit” referred to here may be executed by software and/or hardware modules and may also be stored in any computer readable non-transitory medium or other storage devices. In some embodiments, a software module may be compiled and connected to an executable program. Obviously, the software module here may respond to information passed by itself or other modules and/or may respond when certain events or interruptions are detected. A software module set to be capable of operating on a computing device (e.g., the processor 220) may be provided on a computer readable medium, and the computer readable medium here may be a disk, a digital disk, a flash disk, a magnetic disk, or any other kind of tangible medium; a software module may also be obtained through a digital download manner (the digital download here may also include data stored in a compressed package or an installation package, which needs to be decompressed or decoded before execution). A software code here may be partly or completely stored in a storage device of the computing device executing the operation and be applied to the operation of the computing device. The software instructions may be embedded in the firmware, such as an erasable programmable read-only memory (EPROM). Obviously, the hardware module may include connected logic units, for example, a gate, or a trigger, and/or programmable units may be included, for example, a programmable gate array or processor. The functions of the modules or computing devices described here are preferably implemented as the software modules but may also be represented in the hardware or the firmware. In general, the module referred here is a logic module and not limited by a specific physical form or storage constraints. A module may be combined with other modules or separated into a series of submodules.

The user input module 301 is configured to receive a user input instruction. In the process of data query, the knowledge map building system 110 needs to determine how to retrive information that the user may need in the database based on the needs of the user. The needs of the user are transmitted to the system by means of instructions. In some embodiments, the user input module 301 may include a graphical interface for inputting characters. For example, a series of characters may be entered in a search box on a display device, and the characters represent a content that the user needs to query in the database. In some embodiments, the user input module 301 may include an operatable graphical interface. For example, some clickable images are presented on a display device, and the user may edit the images through a mouse or a keyboard, and the edited content may be the user input data. In some embodiments, the user input module 301 may include a voice input apparatus, and the voice input apparatus may capture voice input of the user, and the user may use the voice or other sources as the user input data. In some embodiments, the user input module 301 may include an image detecting apparatus, and the image detecting apparatus may detect an image in a certain region in real-time. The user may place an image with command information in the region, and the image detecting apparatus may detect the image with the command information, and the detected image may be the user input data. For example, the image with the command information may be a barcode, a two-dimensional code, or other similar images. The user input data may be directly transferred to the analysis module 302 for processing or may be temporarily stored in the storage module 307 for being retrieved later. The storage module 307 may have a storage unit for storing user input instructions, and the storage unit may be configured to call the instructions of clients at any time during the system operation.

The analysis module 302 may be configured to process the instructions entered by the user. The instructions may be obtained directly from the user input module 301 or may also be the user instructions previously stored in the storage module 307. In the present disclosure, the analysis based on the user input instructions is specifically performed by identifying a data node related to the user input data in a database based on the user input data. The data node in the database may contain multi-element attribute information, for example, in the field of film and television media, a data node may be the name of a film and television program. Sub-information associated with the name of the film and television programs may include corresponding authors, screenwriters, directors, actors, investment companies, satellite television channels, or other information. When the user input data is one of the sub-information, the data node may be found through the analysis module 302. In some embodiments, the user input data is first classified after being received through the analysis module 302. For example, when user input information is “Zhang Yimou”, the analysis module 302 first classifies the user input information as a name. In the subsequent query, the search may be preferably conducted in the database among categories such as author, screenwriter, director, actor, or the like, rather than types such as investment company, satellite television channel, release time, etc.

In some embodiments, more than one related nodes may be retrieved based on the user input data. Then the analysis module 302 may select one of the nodes as the most relevant node, and the selection mechanism may be a sort function. For example, the user input data is “Zhang Yimou”, and the analysis module 302 may find multiple people named Zhang Yimou when searching for a node. Among these people, there may be a director, a screenwriter, or an actor. The analysis module 302 may sort similar data nodes based on the number of occurrences of the name of a person in the database or statistics information such as a click volume on the internet. A retrieved result with the relatively high click volume of the occurrences may be the most wanted result of the user of the input data, then the director Zhang Yimou may be identified as a target data node.

After obtaining a target node based on user input data, other nodes associated with it are required to form a complete knowledge map, so the analysis module 302 may associate the determined target node with other nodes to get more association nodes related to the target node. The association is associated may be based on sub-information in the target node or may be based on whether the sub-information in other data nodes contains the determined target node information. For example, in some embodiments, the target node that has been found is the name of a certain film and television programs, the association rule may be further retrieved based on the sub-information (such as a scriptwriter, a director, an actor, or the like.) included in the name of the film and television programs to find corresponding producer information of the film and television programs. The query may be further conducted in a database using the name of the film and television programs as a keyword, and other data nodes associated with the film and television programs may be retreived.

After the association process is conducted, the analysis module 302 may finally determine that a portion of the data nodes is to be ultimately presented to the user and a portion of the nodes that are less relevant may be removed. after a portion of related nodes are retrieved in the association process, the nodes are ranked. The basis for ranking the nodes may be a click volume of the nodes on the internet. Based on the final ranking result, the nodes with a relatively high click volume may be determined as the nodes to be finally presented to the user, and the other nodes with a relatively low click volume may be removed as noise. After processing by the analysis module 102, a series of data nodes are extracted for subsequent processing. The extracted data node information may be stored in the storage module 307 or may be directly obtained by the report generation module 303 and/or the knowledge map generation module 304.

The node information determined by the analysis module 302 is continuously provided to the report generation module 303 and the knowledge map generation module 304. The report generation module 303 may further organize based on the data provided by the analysis module 302 to create a more intuitive data report. For example, In some embodiments, the report generation module 303 receives data from the analysis module 302, which may include a target node that is the name of the film and television programs and one or more associated nodes such as actor information, director information, or the like, then the report generation module may create a table to record this information. Users may also define a report type of the report that needs to be created in the report generation module. For example, when the target node is known as the name of a film and television program, the user wants to know which satellite television channels play the film and television programs. At this time, the report generation module 303 receives the satellite television channels without the film and television programs from the analysis module 302, and then the analysis module 302 may receive the report generation request data from the report generation module 303 and retrieve the data again in the database. The newly retrieved data node information after re-retrieval may be made into a data report through the report generation module 303.

The knowledge map generation module 304 may build a knowledge map to be presented to the client based on the node data generated through the analysis module 302. The node data obtained from the analysis module 302 may include a target node and one or more association nodes. Since these association nodes are associated based on the target data node, and a correlation may be between the association nodes and the target node. For example, the target node is “Jinling Thirteen”, one of the association nodes is “Zhang Yimou”, and then the correlation between the two data nodes is a director. Similarly, other association nodes may have such a correlation with the target node. The knowledge map generation module 304 may sort the correlation between the target node and the association nodes and graphically represent the relation. In some embodiments, the target node is represented by a central element ball, and the other association nodes are represented by similar element balls and surround the element ball of the target node. The target node element ball is connected to the association node element ball by a solid line, and the correlation between the two nodes is indicated. In some embodiments, more than one correlation between the target node and one of the association nodes may be present. For example, if a director and a screenwriter of a movie are the same person, and then more than one connection line may be between the corresponding target node element ball and the association node element ball to indicate multiple correlations between the two. In some embodiments, some correlations may be between a plurality of association nodes. For example, a director of a film and television program is Zhang San, an investor is company A, and the Zhang San happens to be affiliated to the company A. A connecting line may be between the corresponding association node element balls to represent the relation between the two association nodes. The connection line may be different from the connection line between the association node element ball and the target node element ball, such as color, thickness, differences between virtual and real, or the like.

The presenting module 306 may be a display device (such as the input/output 260), which may be configured to render the knowledge map generated in the report generation module 303 and/or the knowledge map generated in the knowledge map generation module 304. The display device may be a computer screen, a mobile phone screen, a television screen, or the like. In some embodiments, the presenting module 306 may be a display device that may interact with the user, such as a computer screen, and the user may operate on the screen with a mouse. In some embodiments, the presenting module 306 may be a touch screen, and the user may operate contents on the screen by touching the screen with a finger. The report or the knowledge map presented on the presenting module 306 may be a user-editable graphic that may be edited by an input device such as a mouse.

The user modification module 305 may receive user instructions from the user input module 301 and modify the report or the knowledge map presented on the presenting module 306. In some embodiments, the user may be not satisfied with the generated knowledge map. All of the association nodes may not be the answers that the user wants. At this point, the user may input an association node that he/she thinks into the system through the user input module 301. The user modification module 305 may modify and edit the generated knowledge map based on the modification from the user. The initially generated part and the user-modified part of the modified knowledge map may be presented distinguishably. The modified knowledge map may be stored in the storage module 307 and stored in the database module 308 and/or the cloud storage module 309 as a supplement to a database. In the process of storing data to the database, the content modified based on the modification instruction of the user and user identity information in the database as a set of data. The user identity information may include a name, an age, an occupation, a literacy level, or the like of the user. When the user-modified data in the database is accumulated to a certain number, targeted retrieval results may be carried out based on the target user identity information to achieve the purpose of big data analysis.

The knowledge map building system also includes the data storage subsystem 311. The data storage subsystem includes the storage module 307, the database module 308, and the cloud storage module 309. The three storage modules may transfer data to each other. The storage module 307 is a storage device for temporarily storing data information. The storage device may include but is not limited to various types of storage devices such as a solid-state drive, a mechanical hard disk, a USB flash drive, an SD memory card, an optical disc, a random-access memory (RAM), and a read-only memory (ROM). The database module 308 is a local storage device or a remote storage server, and the database retrieved in the analysis module 302 may be stored in the database module 308. The data in database module 308 may be retrieved by the analysis module 302 and transferred to the data processing subsystem 310 through the storage module 307. The cloud storage module 309 is a series of remote storage servers. The remote storage server may perform data updates on the database module 308 and may also be directly accessed by the storage module 307. The cloud storage module 309 may include information other than the database to be retrieved, for example, an operation related to the sorting based on the click volume on the internet in the process of retrieval. The information of the click volume on the internet may not be contents in the database to be retrieved, but may be retrieved in the cloud storage module 309. At this time, the storage module 307 may transmit transmitted instructions in the analysis module 302 to the cloud storage module 309 to process retrieve.

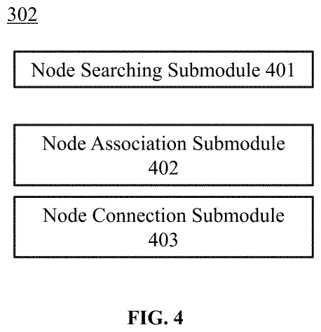

FIG. 4 is a schematic diagram of an analysis module according to some embodiments of the present disclosure. The analysis module 302 may include a node searching submodule 401, a node association submodule 402, and a node connection submodule 403. After the user input data instructions are transmitted to the analysis module 302, the node searching submodule 401 first retrieves in the database based on the user input data to determine the most relevant target node. The searching the database and the determining the most relevant target node may include a function of retrieving and sorting. For example, the node searching submodule 401 finds a plurality of related retrieved results in the database based on the user input data, and the retrieved results may be arranged in a certain order, and the most relevant target node is determined based on the sort order. The order may be matching a degree of the keyword, a storage amount of the retrieval results in the database, a click volume of the retrieval results on the internet, or the like. Determining the most relevant target node based on the sorting order may be the first search result of the sorting order as the target node.

The node association submodule 402 is configured to extend the target node. After entering a search term, the user may want to know other information related to the search term. The role of the node association submodule 402 is to obtain other associated association nodes based on a known node. The known node may be a target node or may be an association node. For example, in some embodiments, after inputting a search term, the user may get a target node and several association nodes. If the user is interested in one of the association nodes at this time, an instruction may be further inputted to obtain more child association nodes associated with the association node. In this process, the node association submodule 402 further search for more child association nodes related to the association node of interest of the user based on the instruction. In some embodiments, the expansion of the association node may also be automatic, without the user input. For example, in some of the retrieved association nodes, some association nodes have high click volumes on the internet, and the association nodes may be expanded by default.

The node connection submodule 403 is configured to determine the correlation between the target node and the association node. In the node association submodule 402, there may be a lot of methods for obtaining the association node based on the target node, but no matter what method is used for the obtaining of the association node, a certain connection may exist between the target node and the association node. The node connection submodule 403 may organize the connections that exist between the nodes. In some embodiments, the node connection submodule 403 performs the organization of the connections of the nodes based on the association rule in the association process. For example, after determining the target node, the association node further searches based on the information included in the target node and further uses the included information as a search term in the database. Then the node connection submodule 403 may record the included information as the correlation between the target node and the association node. In addition, in addition to recording the included information as the correlation between the target node and the association node, the node connection submodule may additionally determine whether other correlations may be present between the target node and the association node. If so, the correlation between the target node and the association node may also be recorded. For example, after the target node is determined, the target node is re-retrieved as a search term in the database, and some retrieval results may be obtained. The connection between the search results and the target node is unknown, and the node connection submodule 403 may determine the correlation between the search results and the target node and record.

It should be noted that the above description of the analysis module 302 is merely a specific embodiment and should not be considered as the only feasible solution. It may be apparent to those skilled in the art that various modifications and changes in form and detail may be made to the analysis module 302 without departing from the principles. However, these modifications and changes are still within the scope of the above description. For example, in some embodiments, the node connection submodule 403 may be included in the node association submodule 402, and a correlation may be automatically generated between the target node and the association node while the association node based on the target node is generated.

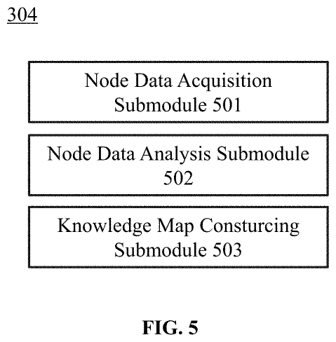

FIG. 5 is a schematic diagram of an example of the knowledge map generation module according to some embodiments of the present disclosure. The knowledge map generation module 304 may include a node data acquisition submodule 501, a node data analysis submodule 502, and a knowledge map constructing submodule 503. The knowledge map generation module 504 may generate knowledge map data based on some node information. The node information may include the target node information, information of a plurality of association nodes, and the correlation between the target node and each of the plurality of association node. The node data acquisition submodule 501 may be configured to obtain the node information. The node information may come from the analysis module 302 and may also come from the storage module 307 or other similar storage devices. In some embodiments, the storage module 307 may already have node information that may be used to construct a knowledge map. For example, when testing the knowledge map generation function, the knowledge map node information may be pre-stored in the storage module 307, and the node information of this part is directly called when the knowledge map is constructed.

The node data analysis submodule 502 may be configured to analyze the obtained node information. Analyzing the obtained node information may include classifying the obtained node information, determining a strength of a correlation between the target node and the association node, or assessing the data quality of the association node. In some embodiments, the classifying the obtained node information may classify the association node based on the correlation between the target node and the association node. For example, the target node is the name of a film and television program. The association node includes some names of actors and some names of satellite television channels that play the film and television programs, and the association nodes of the names of the actors may be classified into one category and the satellite television channels that play the film and television programs may be classified into one category. In some embodiments, determining the strength of the correlation between the target node and the association node may be based on the number of simultaneous occurrences of the target node and the association node on the internet. For example, the target node is the name of a film and television program, an association node 1 is the name of a starring in the film and television programs, and an association node 2 is the name of a supporting role in the film and television programs. On the internet, the number of simultaneous occurrences of the name of the film and television programs and the name of the starring in the film and television programs may be greater than the number of simultaneous occurrences of the name of the supporting role. At this time, it may be determined that the strength of the correlation of the target node and the association node 1 is stronger and the strength of the correlation of the target node and the association node 2 is weaker. In some embodiments, the assessing the data quality of the association node may be performed by retrieving the association node in the database, and the quality of the association node may be determined based on the number of retrieval results. For example, an association node 1 is the name of company A, and an association node 2 is the name of company B. In the database, the number of information of the company A is significantly more than the number of information of the company B, then it may be determined that the quality of the association node 1 is better than the quality of the association node 2.

The knowledge map constructing submodule 503 may construct a knowledge map based on the node data obtained in the node data acquisition submodule 501 and the analysis data of the node information in the node data analysis submodule 502 to obtain image data. The knowledge map constructing submodule 503 may cause the obtained node information to be presented on a plane and determine a location of each of the nodes based on the analysis of the node data. In some embodiments, the knowledge map constructing submodule 503 may put the target node in a central position and arrange one or more association nodes around the target node, and the target node may be connected with each of the one or more association nodes by using a line, and a correlation between the target node and the association node may be annotated on the line. The arrangement of the association nodes around the target node may be conducted based on node analysis data by the node data analysis submodule 502. In some embodiments, the arrangement may be based on a classification of the association node. For example, in the node data analysis submodule 502, a correlation between a part of association nodes and a target node may be determined as an actor, and a correlation between another part of the association nodes and the target node may be determined as a satellite television channel When laying out the association nodes, the association node with the target node as the actor may be arranged as a cluster, and the association node with the target node as the satellite television channel may be arranged as a cluster. The arrangement may be conducted based on a strength of a correlation between the association node and the target node. For example, the node data analysis submodule 502 determines that the correlation between a part of the association nodes and the target node is stronger than other parts of the association nodes. The association node with a stronger correlation may be arranged closer to the target node, or the connection line between an element ball and the target node element ball may be thicker. In some embodiments, the arrangement may be conducted based on the data quality of the association node. For example, if the node data analysis submodule 502 determines that the data quality of a part of the association nodes is high, then the element ball of the part of the association nodes may be larger.

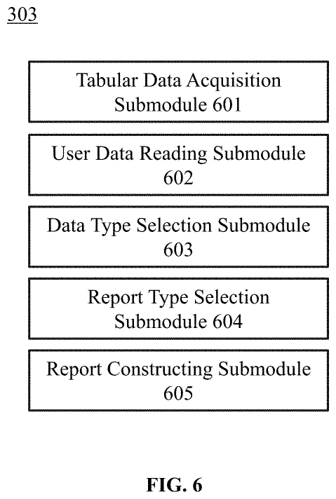

FIG. 6 is a schematic diagram of an example of a report generation module according to some embodiments of the present disclosure. The report generation module 303 may include a tabular data acquisition submodule 601, a report type selection submodule 602, a data type selection submodule 603, a user data reading submodule 604, and a report constructing submodule 605. The report generation module 303 may generate a data report based on some node information. The node information may include target node information, association node information, and a correlation between the target node and the association node. The node information may be the same batch data information used to construct a knowledge map. The tabular data acquisition submodule 601 may be configured to obtain the node information. The node information may come from the analysis module 302 and may also come from the storage module 307 or other similar storage devices. In some embodiments, the node information for generating reports may be stored in the storage module 307. For example, when a test report is generated, the node information may be pre-stored in the storage module 307, and the part of the node information may be directly called during the generation.

The user data reading submodule 602 may be configured to read the user information to assist in completing the report generation function. The information may be stored in the storage module 307, such as the usual usage habits of the user. The usage habits may include frequently selected report types, frequently selected data types, or the like. In the process of report generation, the information of the usage habits of the user may be as the basis for determining the report type of the report or the type of the data pushed to the user. For example, in some embodiments, the user usually pays attention to the audience ratings of a film and television program in each of various satellite television channels, and the system may preferentially recommend a report of the type of the data to the user in the process of the report generation. In some embodiments, the type of devices used by the user may also be used as a basis of determining for pushing the report type of the report or the type of data to the user. For example, when a user uses a device with a small screen such as a mobile phone or a tablet computer, the system may push some of the more streamlined chart types to the user.

The report type selection submodule 603 may be configured to select the report type of the report to be generated. The report type of the report may include a table, a statistics chart, a text description of a certain format, or the like. The statistics chart may include a statistics chart such as a line chart, a pie chart, a histogram, or the like. The text description of the certain format may be a pre-designed text and may be filled or modified based on the data obtained by the tabular data acquisition submodule 601 at some fixed position of the text. The user may select the report type of the report that needs to be generated based on the needs, and multiple reports may also be generated at the same time for the user to select from.

The data type selection submodule 604 may be configured to perform data filtering on the node data obtained in the tabular data acquisition submodule 601. The data filtering may be performed based on the selected report type result in the report type selection submodule 603. For example, if the report type selected by the user is a broken line statistics chart, the data type selection submodule 604 may filter the obtained node data to obtain node information including a number. The data filtering may also be conducted based on the needs of the user. For example, if the user wants to know the audience rating of a film and television program in each of various satellite television channels, and the data type selection submodule 604 filters the obtained node data to obtain node information related to the satellite television channels and the related audience rating. The report constructing submodule 605 may be configured to construct a report based on the obtained tabular data, the report type of the report, the type of data, the user data, or the like. The report constructing submodule 605 may construct a single report based on the series of information or may also construct a plurality of reports. For example, the user may be unsure about which report type is suitable for presenting the distribution of data; and the user may have selected the report type in advance. The report constructing submodule 605 may simultaneously push other types of reports for user reference after constructing the report based on the user instructions. The report constructing submodule 605 may also superimpose a plurality of constructed reports. For example, if the user wants to know the recent audience ratings of two film and television programss, he/she may first construct a report of the first film and television programs, then construct the report of the second film and television programs, and then superimpose the two reports to visually compare the recent audience rating difference between the two film and television programss.

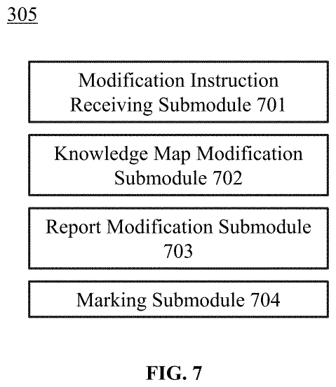

FIG. 7 is a schematic diagram of an example of a user modification module according to some embodiments of the present disclosure. The user modification module 305 includes a modification instruction receiving submodule 701, a knowledge map modification submodule 702, a report modification submodule 703, and a marking submodule 704. The user modification module 305 may allow the user to modify the presented knowledge map and/or report based on his/her own needs to modify the knowledge map and/or the report. The modification instruction receiving submodule 701 may be configured to receive user modification instructions. The modification instructions may be obtained by the user input module 301. The modification instructions may be keyboard input, finger touch, voice input, or the like.

The knowledge map modification submodule 702 may modify the knowledge map based on the user instructions received by the modification instruction receiving submodule 701. The modification may include modifying graphics or texts on the existing knowledge map, adding elements that are not on the existing knowledge map, or the like. Modifying the graphics or texts includes deletion, addition, or the like. In some embodiments, after reviewing the presented knowledge map, the user may think that it is not accurate enough to meet the user expectations. For example, the target node is the name of a movie and television performance, and each association node connected to it includes an actor class, a director class, and a broadcast satellite television channel class, but a company class or the like is not included, then the user may manually add an association node as an investment company of the film and television programs and mark the investment company in the connection line between the association node and the target node. For another example, an association node of the target node is an actor A, and the correlation is the main role, but the user thinks that that actor A is not the starring of the film and television programs and then may input an instruction to modify the correlation as an actor. The adding the elements that are not included may be a user input instruction adding an association node and connecting to the target node, and the name of the association node and the correlation with the target node are also inputted by the user.

The report modification submodule 703 may modify the report based on the user instructions received by the modification instruction receiving submodule 701. The modification may include modifying graphics or texts on the existing report, adding elements that are not on the existing report, or the like. The modification of the graphics or texts includes deletion, addition, or the like. In some embodiments, after reviewing the rendered report, the user may think that it is not accurate enough to meet user expectations. For example, the user wants to know each of a proportion of audience ratings of a film and television program, and the histogram of the report constructed by the system, the user may think that the histogram does not directly reflect the proportion. At this point, the user may manually modify the report type of the report to a pie chart to more intuitively reflect the proportion of the audience ratings.

The marking submodule 704 may be configured to mark a content modified based on the modification instruction of the user in the knowledge map modification submodule 702 and the report modification submodule 703 and store the content modified based on the modification instruction of the user and user identity information in the database. The mark may include color, virtual and shadow processing on the element ball of the association node in the knowledge map and its connection with the target node element ball, the report type of the report in the report, and the modification of the report data range. For example, in some embodiments, the association node added by the user and its connection with the target node is indicated by a broken line. The user identification information may include the name, the age, the occupation, the literacy level, or the like of the user. Since the user identity information may have some connections with the content modified based on the modification instruction of the user, such the connections may record the user research preferences and analysis direction. Therefore, the content modified based on the modification instruction of the user and the user identity information is stored in the database may be a basis of big data analysis.

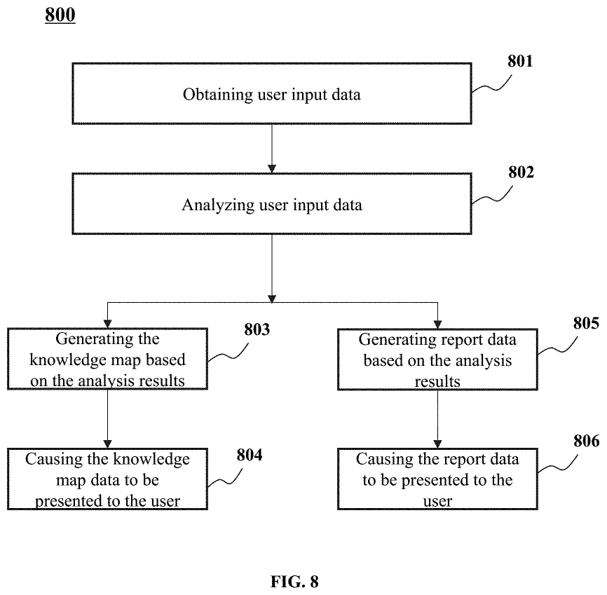

FIG. 8 is an exemplary flowchart for building the knowledge map according to some embodiments of the present disclosure. The flowchart illustrates a basic flow of generating a knowledge map and a report according to the present disclosure. In step 801, the knowledge map building system 110 first obtains user input data. This step may be implemented through the user input module 301. The obtained user data may be a instruction that the user inputs to the knowledge map building system 110 for building a knowledge map for the first time, or may be a modification instruction of the user for modifying the obtained knowledge map. In some embodiments, the user input data may be a series of characters, a touch instruction on a touchable display screen, an operation instruction via a mouse and a keyboard, a voice input, or an image input. For detailed examples, a description of the user input module 101 may be referred, which is not described here.

In step 802, the knowledge map building system 110 may analyze the user input data obtained in step 601 based on a database. This step may be implemented through the analysis module 302. In the present disclosure, the analysis data may specifically include retrieving a data node associated with user input data in a database and extracting data node information to facilitate subsequent knowledge map generation. In step 802, the analysis module 302 first determines a target node based on the search result and then associate the determined target node with other nodes, thereby one or more association nodes of certain columns are obtained. There is a correlation between the association nodes and the target node. A description of how to determine the target node and the association nodes may refer to a relevant description in the analysis module 302. In this step, the analysis result may include target node information, information of a series of association nodes, and a correlation between the target node and the series of association nodes.

In step 803, the system may generate knowledge map data based on the analysis results in step 802. This step may be implemented through the knowledge map generation module 304. In some embodiments, the knowledge map generation module 304 builds a knowledge map based on the target node information, the association node information, and the correlation between the target node and each association node. For example, the target node is represented by an element ball located in a central position, and the association nodes are represented by similar element balls surrounding the element ball of the target node. The target node element ball is connected to the association node element ball by a solid line, and the correlation between the two nodes is indicated by the solid line. In some embodiments, more than one correlation between the target node and one of the association nodes may be present. For example, a director and a screenwriter of a movie are the same person. There may be more than one solid line between the corresponding target node element ball and the association node element ball to indicate multiple correlations between the target node and the associate node. Other related knowledge map generation methods may refer to a description of the knowledge map generation module 304.

In step 804, the knowledge map building system 110 may cause the knowledge map data obtained in step 803 to be presented to the user. This step may be implemented by the presenting module 306. The presentation may be implemented on a display device. The display device may be a computer screen, a mobile phone screen, a television screen, or the like. A description of the presentation process may refer to a description of the presenting module 306.

In step 805, the knowledge map building system 110 may generate a report based on the analysis results in step the 802. This step may be implemented through the report generation module 303. In some embodiments, the system generates a report based on the target node information, the association node information, the correlation between the target node and each associated node, and some other auxiliary information. For example, in some embodiments, data received by the report generation module 303 may include a target node that is the name of a film and television program, and one or more associated nodes such as actor information, director information, or the like. Then the report generation module may create a table to record these information. Other related report generation methods may refer to a description of the report generation module 303.

In step 806, the knowledge map building system 110 may cause the report data obtained in step 805 to be presented to the user. This step may be implemented through the presenting module 306. The presentation may be conducted on a display device. The display device may be a computer screen, a mobile phone screen, a television screen, or the like. A description of the presentation process may refer to the description in the presenting module 306.

After presenting the obtained knowledge map and/or report, the user may determine whether the presented knowledge map and/or report is qualified. The determination of whether the knowledge map and/or the report is qualified may be conducted via a determination of whether information that the user wants to obtain is presented in association nodes or form. If yes, the presented knowledge map and/or report is determined as qualified, and if not, the presented knowledge map and/or report is determined as unqualified. If the result of the determination is qualified, the knowledge map and/or the report building process ends. If the determination is unqualified, then step 801 may be performed again to wait for user input to build the knowledge map and/or the report. In some embodiments, rebuilding the knowledge map and/or the report may include that after the user inputs the data again, step 802 is executed to obtain a new target node and a series of association nodes. In some embodiments, when the user approves one of the association nodes in the knowledge map that has been presented, the building the knowledge map may include that the user determines one of the association nodes as a new target node, then, when step 802 is executed for the second time, a previously approved association node and a series of child association nodes with the approved association node are obtained. Thus, the re-built knowledge map in step 803 is a graph of an initial knowledge map plus child association node(s) of the approved association node. After the knowledge map is presented to the user again through the steps 804 and/or 806, the user then determines whether the newly generated knowledge map and/or report is qualified. If not, then step 801 may be performed again to iterate.

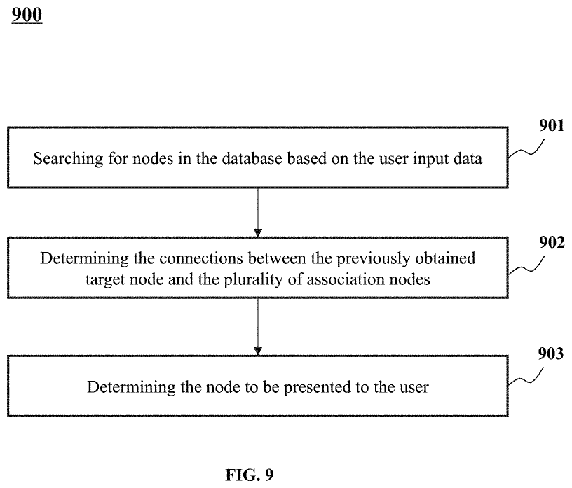

FIG. 9 is an exemplary flowchart for analyzing user input data based on data in a database in a process of building the knowledge map according to some embodiments of the present disclosure. In some embodiments, step 802 in the process 800 shown in FIG. 8 may be implemented by the process 900.

First, in step 901, the knowledge map building system 110 may search for nodes in the database based on the user input data. The nodes may include a target node and a plurality of association nodes. The search for the nodes may be implemented through the node searching submodule 401 and the node association submodule 402 in the analysis module 302. Related methods of how to search for a node may refer to a description of the node searching submodule 401 and the node association submodule 402. By performing the step 901, a target node and a plurality of association nodes may be determined.

In step 902, the connection between the previously obtained target node and the plurality of association nodes may be determined. This step may be implemented through the node connection submodule 403 in the analysis module 302. In the node search of step 901, the search of the plurality of association nodes is determined based on the target node based on a certain logic algorithm, so a certain correlation may be between the target node and the association nodes. Related methods of determining the correlation may refer to the description of the node connection submodule 403.

In step 903, the node to be presented to the user is determined. This step may be implemented through the node searching submodule 401 and the node association submodule 402 in the analysis module 302. After obtaining a series of association nodes and determining the correlation between the association node and the target node, a selection of the association nodes may be performed to remove a portion of the association nodes that is less relevant to the target node. For example, after a portion of related nodes are retrieved in the association process, the nodes are ranked. The basis for ranking the nodes may be a click volume of the nodes on the internet. Based on the final ranking result, the nodes with a relatively high click volume may be determined as the nodes to be finally presented to the user, and the other nodes with a relatively low click volume may be removed as noise. Through the determination in step 903, the target node and the association node are obtained after filtering, and the node information may be used to construct the knowledge map and/or the report.

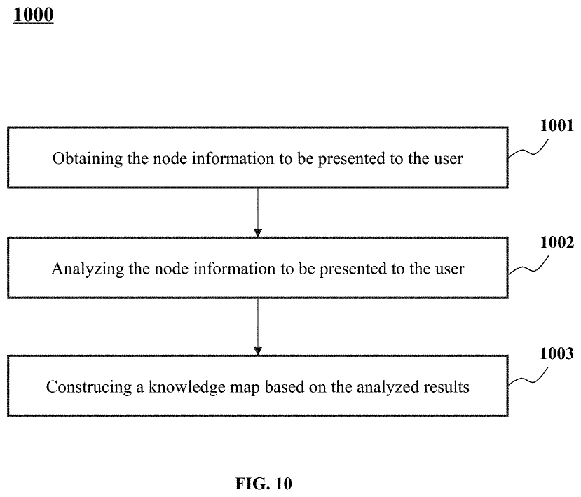

FIG. 10 is an exemplary flowchart of generating the knowledge map based on the analysis result according to some embodiments of the present disclosure. In some embodiments, step 803 in the process 800 shown in FIG. 8 may be implemented through the process 1000. In step 1001, the knowledge map building system 110 may obtain the node information to be presented to the user. The obtaining process may be implemented through the node data acquisition submodule 501 in the knowledge map generation module 304. The node information may be filtered or may be unfiltered. The node information may include the target node information, information of a plurality of association nodes, and the correlation between the target node and each of the plurality of association node.

In step 1002, the knowledge map building system 110 may analyze the node information to be presented to the user. The analysis process may be implemented through the node data analysis submodule 502 in the knowledge map generation module 304. Related analysis methods may refer to a description of the node data analysis submodule 502. After the analysis, the association node is classified, the strength of the correlation between the association node and the target node is determined. The analysis results of the data quality of the association node may be used as the basis for the subsequent construction of the knowledge map.

In step 1003, the knowledge map building system 110 may construct a knowledge map based on the analysis results. The process of constructing the map may be implemented through the knowledge map constructing submodule 503 in the knowledge map generation module 304. The constructed knowledge map may present all the obtained node information on a plane. In some embodiments, the target node may be disposed in a central position, and the one or more association nodes may be arranged around the target node. The target node may be connected with each of the one or more association nodes using a line, and a correlation between the target node and the association node may be annotated on the line. The arrangement of the association nodes around the target node may be conducted based on the analysis results. Related arrangement methods may refer to the description in the knowledge map constructing submodule 503.

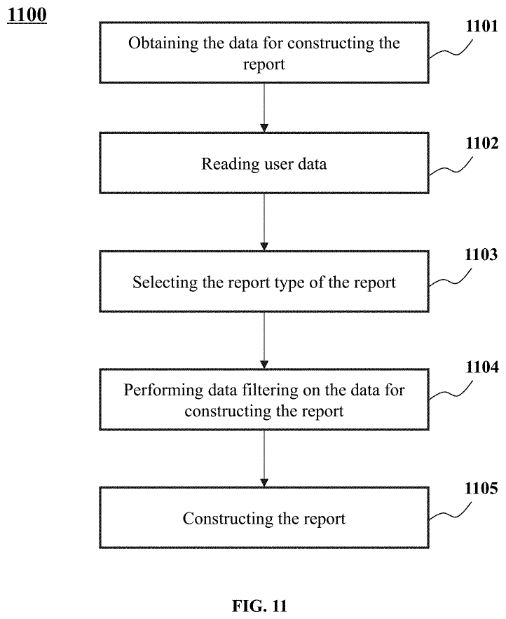

FIG. 11 is an exemplary flowchart of report generation according to some embodiments of the present disclosure. Step 805 in the process 800 shown in FIG. 8 may be implemented by the process 1100. In step 1101, the knowledge map building system 110 may obtain the data for constructing the report. The function of obtaining the data for constructing the report may be implemented through the tabular data acquisition submodule 601. The data for constructing the report may be the analysis results in step 802. The analysis results may include the target node information, information of a plurality of association nodes, and the correlation between the target node and each of the plurality of association node.

In step 1102, the knowledge map building system 110 may read user data. The user data may be read through the user data reading submodule 602. The user data may be used to assist in implementing the report generation function. Related methods that use user data to assist in generating the report may refer to a description of the user data reading submodule 602.

In step 1103, the knowledge map building system 110 may select the report type of the report that needs to be generated. The function of selecting the report type of the report may be implemented through the report type selection submodule 603. The report type of the report may include a table, a statistics chart, a text description of a fixed format, or the like. The statistics chart may include a statistics chart such as a line chart, a pie chart, a histogram, or the like. The text description of a fixed format may be a pre-designed text. The pre-designed text may be partly filled or modified at some fixed locations. The user may select the report type of the report that needs to be generated based on the needs and may also generate multiple reports at the same time for the user to select from.

In step 1104, the knowledge map building system 110 may perform data filtering on the previously obtained node data. The data filtering function may be implemented through the data type selection submodule 604. The data filtering may be performed based on the report type. For example, if the report type selected by the user is a broken line statistics chart, then the node information including numbers may be filtered from the obtained node data. The data filtering may also be performed based on the needs of the user. For example, the user wants to know the audience ratings of a certain film and television program in each of the satellite television channels, and the node information related to the satellite television channels and related audience ratings may be filtered.

In step 1105, the knowledge map building system 110 may perform a report construction based on the previously obtained tabular data, the report type selection result, the data type selection result, the user data, or the like. The function of constructing the report may be implemented by the report constructing submodule 605. The method for constructing the report may refer to related description of the report constructing submodule 605.

It should be noted that the above description of the report generation process is only a specific embodiment and should not be regarded as the only feasible solution. Obviously, those skilled in the art, after understanding the basic principles, may make various modifications and changes in the form and details of the report generation process without departing from the principle. However, these modifications and changes are still within the scope of the above descriptions. For example, in some embodiments, the step 1103 of selecting the report type of the report and the step 1104 of filtering the report data may be conducted in a reversed order or may be performed simultaneously. For example, in some embodiments, the step 1102 of reading the user data may be unneeded. In the process of constructing reports, the user data may be implemented without reference to the user data.

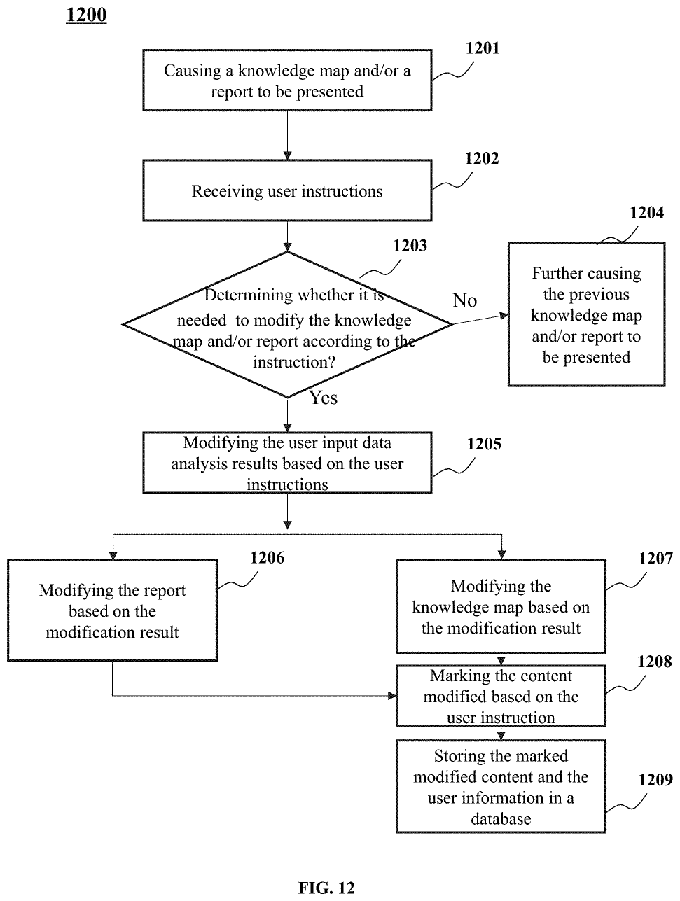

FIG. 12 is an exemplary flowchart of modifying the knowledge map by a user according to some embodiments of the present disclosure. In step 1201, the knowledge map building system 110 may cause a knowledge map and/or a report to be presented. The presented knowledge map and/or report may be built by the method of building a knowledge map as described above or may be a knowledge map and/or report pre-stored in a certain storage device. For example, in some embodiments, a storage stores a plurality of knowledge maps and/or report data, and when the user inputs a retrieval instruction, the knowledge maps and/or the report data may be directly outputted from the storage. The presentation may be implemented through the presenting module 306. The presentation may be implemented on a display device. The display device may be a computer screen, a mobile phone screen, a television screen, or the like. The correlation for the duration of the present process may be described in the description of the presenting module 306.

In step 1202, the knowledge map building system 110 may receive the user instructions. The receiving the user instructions may be implemented through the modification instruction receiving submodule 701. The user instructions may be instructions of the user to modify the knowledge map based on the presented knowledge map and/or report. The modification instructions may be keyboard input, finger touch, voice input, or the like.

In step 1203, the knowledge map building system 110 may determine whether the knowledge map and/or the report needs to be modified based on the received user instructions. For example, in some embodiments, the user instructions may be instructions for modifying the knowledge map and/or the report, or instructions that no modification is needed and that the original knowledge map and/or report may be presented. When it is not needed to modify the knowledge map and/or the report based on the user instructions, step 1204 is performed; when it is needed to modify the knowledge map and/or the report based on the user instructions, step 1205 is performed. In step 1204, the knowledge map building system 110 may further cause the previous knowledge map and/or report to be presented on the original display device without modification.

In step 1205, the knowledge map building system 110 may modify the prior analysis results of user input data of the analysis module 302 based on the user instructions, that is, the data node information used to construct the knowledge map and/or the report may be modified. The modification may be to add or delete the number of the association nodes, modify the correlation between the association nodes and the target node, or modify the data content of the association nodes. Since the user input data analysis result is shared when the knowledge map and/or the report is constructed, the modification of the user input data analysis result may be implemented by automatically modifying the corresponding map and/or report to update the corresponding report and/or knowledge map.

In step 1206, the knowledge map building system 110 may modify the report based on the modified analysis results of user input data. The modification report may be implemented through the report modification submodule 703. The modification may include modifying graphics or texts on the existing report, adding elements that are not present in the report, or the like. The modification of the graphics or the texts includes deleting data, adding data, or the like.

In step 1207, the knowledge map building system 110 may modify the knowledge map based on the modified analysis results of user input data. This modification may be implemented through the knowledge map modification submodule 702. Related modification methods may refer to a description of the knowledge map modification submodule 702.

In step 1208, the content modified based on the modification instruction of the user may be marked. This mark function may be implemented through the marking submodule 704. The modified knowledge map and/or report may be different from the previously presented knowledge map and/or report. These different places may be marked as hints to the user. For the knowledge map, the mark may include coloring, virtual and shadow processing on the element ball of the association node and its connection with the target node element ball. For the report, the mark may include a chart type, a modification of the content, a modification of text content in the text, or the like. For example, in some embodiments, the association node added by the user and its connection with the target node may be indicated by a dotted line.

In step 1209, the system may store the marked modified content and the user information in a database. The user identity information may include a name, an age, an occupation, a literacy level, or the like of the user. Since the user identity information may have some connections with the content modified based on the modification instruction of the user, such the connections may record the user research preferences and analysis direction. Therefore, the content modified based on the modification instruction of the user and the user identity information is stored in the database may be a basis of big data analysis.

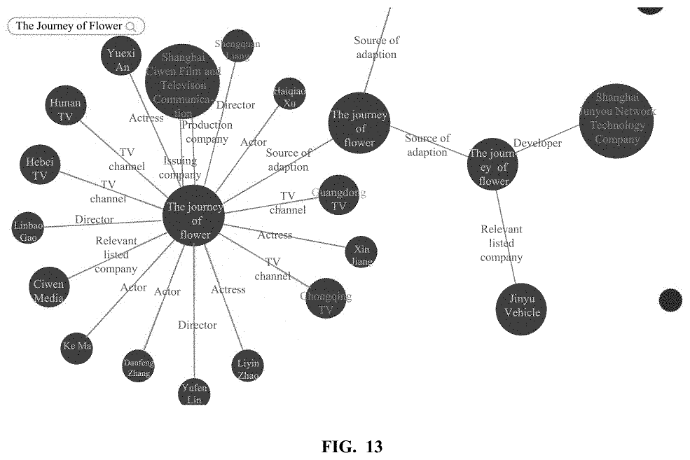

FIG. 13 is an example of the knowledge map according to some embodiments of the present disclosure. In this example, the user input data is “The Journey of Flower”. The correspondingly retrieved target node may be the element ball marked as The Journey of Flower in the center. A series of the association nodes of the target node are arranged around the target node. These association nodes are connected to the target node by solid lines. These solid lines are used to describe the correlation between the association nodes and the target node. For example, Liying Zhao is an actor in the production “The Journey of Flower”. Chongqing satellite television channel is the satellite television channel that plays this production. The element balls of some association nodes are relatively large, and element balls of some are relatively small. For example, the association node of Shanghai Ciwen Film and Television Communication is larger than other association nodes. In addition, more than one correlation between the association nodes and the target node may be present. The Shanghai Ciwen Film and Television Communication is both a production company and an issuing company of “The Journey of Flower”. The correlation between one of the association nodes labeled “The Journey of Flower” and the target node indicates the source of adaptation. When the user wants to further know about the source of the film and television programs, the user may click on the association node, and then the association node may further be expanded with child association node(s).

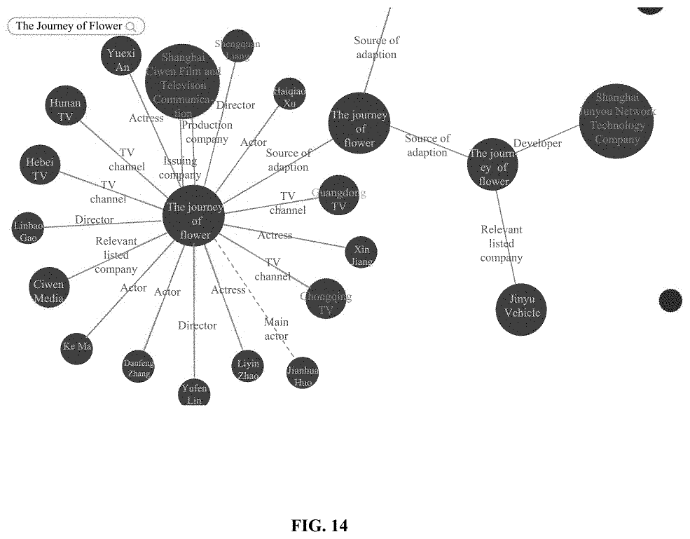

FIG. 14 is an example of the knowledge map according to some embodiments of the present disclosure. In the example of FIG. 11, if the user thinks that the presented knowledge map is not very satisfactory, he/she may modify it. For example, in this example, the user may manually add an association node element ball and mark it as “Jianhua Huo”, and then the correlation between the association node and the target node is determined as the main actor. In order to distinguish the modified content from the content of the originally presented knowledge map, the knowledge map building system 110 may set a connection between the manually added association node and the target node as a dotted line. The knowledge map building system 110 may store the modified knowledge map and the user information in the database.

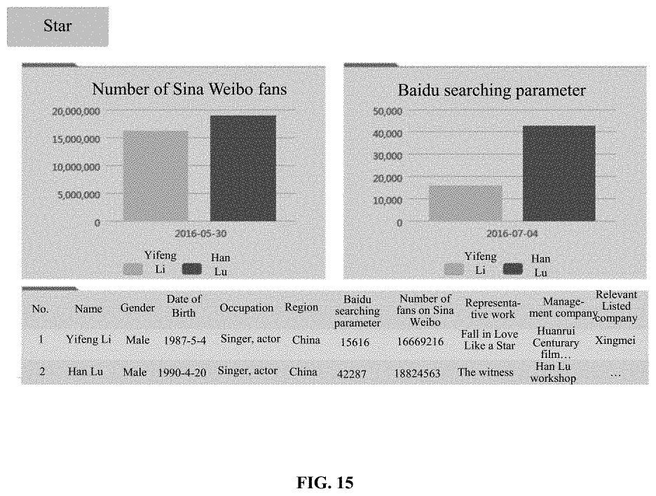

FIG. 15 is an example of the report generation according to some embodiments of the present disclosure. For example, in two successive retrievals, the user inputs “Yifeng Li” and “Han Lu” as keywords to retrieve the target node and obtains a series of data of nodes. Then the knowledge map building system 110 may filter the data of the nodes based on the user needs and obtain a chart in this example. For example, a type of the chart selected by the user is a histogram, and the data of the selected report is the number of Sina Weibo fans and the Baidu searching parameter, and then two histograms as shown in the figure may be generated. In addition, if the report type of the report that the user selected is a table, and the type of the data such as name, gender, date of birth, or the like, is selected as shown in the figure, then a table may be generated as shown.

The basic concept has been described above, and it is obvious to those skilled in the art that the disclosure is by way of example only and does not constitute a limitation of the present disclosure. Various modifications, improvements, and adaptations of the present disclosure may be made by those skilled in the art, although not explicitly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various parts of this specification are not necessarily all referring to the same embodiment. In addition, certain features, structures, or features of one or more embodiments of the present disclosure may be combined as appropriate.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python, or the like, conventional procedural programming languages, such as the “C” programming language, Visual Basic, Fortran 2003, Perl, COBOL 2002, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

In the same way, it should be noted that in order to simplify the description disclosed in the present application and thereby help to understand one or more embodiments, the above description of the embodiments of the present application sometimes incorporates multiple features into one embodiment, one figure or one description of it. However, this disclosure method does not mean that the present disclosure object requires more features than the features mentioned in the claims. Rather, claim subject matter lies in less than all features of a single foregoing disclosed embodiment.

In some embodiments, the numbers expressing quantities of ingredients, properties, and so forth, used to describe and claim certain embodiments of the application are to be understood as being modified in some instances by the term “about,” “approximate,” or “substantially”. Unless otherwise stated, “about,” “approximate,” or “substantially” may indicate ±20% variation of the value it describes. Accordingly, in some embodiments, the numerical parameters set forth in the description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each patent, patent application, patent application publication and other materials cited herein, such as articles, books, instructions, publications, documents, etc., are hereby incorporated by reference in their entirety. Application history documents that are inconsistent or conflicting with the contents of the present application are excluded, and documents (currently or later attached to the present application) that limit the widest range of the scope of the present application are also excluded. It is to be noted that if the description, definition, and/or terminology used in the appended application of the present application is inconsistent or conflicting with the contents described in this application, the description, definition and/or terminology may be subject to the present application.

At last, it should be understood that the embodiments described in the present application are merely illustrative of the principles of the embodiments of the present application. Other modifications that may be employed may be within the scope of the application. Thus, by way of example, but not of limitation, alternative configurations of the embodiments of the application may be utilized in accordance with the teachings herein. Accordingly, embodiments of the present application are not limited to the embodiments that are expressly introduced and described herein.

What is claimed is:

1. A method for building a knowledge map comprises:
obtaining user input data;
querying a database based on the user input data to obtain data node information, the data node information including target node information and association node information related to the target node information;
analyzing the data node information;
constructing a knowledge map based on the analysis result;
causing the knowledge map to be presented to the user;
receiving from the user a modification instruction for modifying the knowledge map; and
causing a modified knowledge map to be presented to the user.

2. The method of claim 1, wherein the querying a database based on the user input data to obtain data node information includes:
identifying a target node in the database based on user data; and
further searching, based on the identified target node, other nodes related to the identified target node in the database as association nodes.

3. The method of claim 1, wherein the analyzing the data node information includes at least one of classifying the data node information, determining a strength of a correlation between the target node and each of the association nodes, or assessing data quality of the association nodes.

4. The method of claim 1, further including:
generating a report based on the analysis result; and
causing the generated report to be presented to the user.

5. The method of claim 4, wherein the generating a report based on the analysis result includes:
obtaining the analysis result;
obtaining user data;
selecting a report type of the report that needs to be generated. filtering the data node information in the analysis result; and
generating the report based on the user data, the selected report type, and the filtered data node information.

6. The method of claim 5, wherein the report type includes at least one of a statistics chart, a statistics table, or a text template of a fixed format.

7. The method of claim 1, wherein the constructing a knowledge map based on the analysis result includes:
putting the target node in a central location;
arranging the association nodes around the target node; and
for each of the association nodes, connecting the target node with the association node using a line and annotating a correlation between the target node and the association node on the line.

8. The method of claim 1, wherein the receiving from the user a modification instruction for modifying the knowledge map and causing a modified knowledge map to be presented to the user includes:
receiving the modification instruction of the user;
modifying the analysis result of the user input data based on the modification instruction of the user;
modifying the knowledge map based on the modified analysis result;
generating a mark for a content modified based on the modification instruction of the user; and
causing the modified knowledge map and the mark to be presented to the user.

9. The method of claim 8, wherein the receiving from the user a modification instruction for modifying the knowledge map and causing the modified knowledge map to be presented to the user further includes:
storing the content modified based on the modification instruction of the user and user identity information in a database.

10. The method of claim 8, wherein the receiving from the user a modification instruction for modifying the knowledge map and causing the modified knowledge map to be presented to the user further includes:
synchronously modifying the report based on the modified analysis result; and
causing the modified report to be presented to the user.

11. A system for building a knowledge map, comprising:
a user input module, configured to obtain user input data;
an analysis module, configured to query a database based on the user input data to obtain data node information and analyze the data node information, the data node information including target node information and association node information related to the target node information;
a knowledge map generation module, configured to construct a knowledge map based on the analysis result;
a presenting module, configured to causing the knowledge map to be presented to the user; and
a user modification module, configured to receive from the user a modification instruction for modifying the knowledge map and causing the presenting module to cause a modified knowledge map to be presented to the user.

12. The system of claim 11, wherein retrieving the database based on the user input data to obtain data node information includes:
identifying a target node in the database based on user data; and
further searching, based on the identified target node, other nodes related to the target node in the database as association nodes.

13. The system of claim 11, wherein analyzing the data node information includes at least one of classifying the data node information, determining a strength of a correlation between the target node and each of the association nodes, or assessing data quality of the association nodes.

14. The system of claim 11, further including:
a report generation module, configured to generate a report based on the analysis result and cause the presenting module to cause the generated report to be presented to the user.

15. The system of claim 14, wherein generating the report based on the analysis result includes:
obtaining the analysis result;
obtaining user data;
selecting a report type of the report that needs to be generated. filtering the data node information in the analysis result; and generating a report based on the user data, the selected report type, and the filtered data node information.

16. The system of claim 15, wherein the report type includes at least one of a statistics chart, a statistics table, or a text template of a fixed format.

17. The system of claim 11, wherein constructing the knowledge map based on the analysis result includes:
putting the target node in a central location;
arranging the association nodes around the target node; and
for each of the association nodes, connecting the target node with the association node using a line and annotating a correlation between the target node and the association node on the line.

18. The system of claim 11, wherein receiving from the user the modification instruction for modifying the knowledge map and causing the presenting module to cause the modified knowledge map to be presented to the user includes:
receiving the modification instruction of the user;
modifying the analysis result of the user input data based on the modification instruction of the user;
modifying the knowledge map based on the modified analysis result;
generating a mark for a content modified based on the modification instruction of the user; and
presenting the modified knowledge map and the mark to the user through the presenting module.

19. The system of claim 18, wherein receiving from the user the modification instruction for modifying the knowledge map and causing the presenting module to cause the modified knowledge map to be presented to the user further includes:
storing the content modified based on the modification instruction of the user and user identity information in a database.

20. The system of claim 18, wherein the receiving from the user the modification instruction for modifying the knowledge map and causing the modified knowledge map to be presented to the user through the presenting module further includes:
synchronously modifying the report based on the modified analysis result; and
causing the modified report to be presented to the user.
